(19) United States
(12) Patent Application Publication
(10) Pub. No.: US 2006/0215484 A1
(43) Pub. Date: Sep. 28, 2006

(54) Emulsion whisk

(76) Inventor: Jared Sokoloff, Sherman Oaks, CA (US)

Correspondence Address: MANATT PHELPS AND PHILLIPS;ROBERT D. BECKER, 1001 PAGE MILL ROAD, BUILDING 2, PALO ALTO, CA, 94304, US

(21) Appl. No.: 11/088,604

(22) Filed: Mar. 24, 2005

(51) Int. Cl. A47J 43/10

(52) U.S. Cl. 366/129

(57) ABSTRACT

A novel type of whisk for dispensing ingredients from the handle of the whisk is a useful and efficient way for emulsifying ingredients, and creating sauces, batters, dressings and the like. A whisk which allows a food preparer to dispense ingredients directly through the whisk itself without having to stop and pour ingredients and suspend the whisking process leads to a better and more consistent emulsion, and greatly reduces awkward and messy two handed cooking. An emulsion whisk includes means for housing ingredients in the inner chamber of the handle and means for dispensing ingredients from the handle directly into a mixing bowl. The whisk may be a singular structure or may be detachable in two-piece units for swapping different types of whisk elements such as balloon whisks, rotary whisks, ball whisks, flat whisks, trimmed whisks and twirl whisks.

### FIELD OF THE INVENTION

The present invention relates generally to a kitchen whisk used in preparing food, and more specifically to an improved kitchen whisk for simultaneously dispensing ingredients and whisking an existing mixture and added ingredients into an emulsion or uniform mixture.

### BACKGROUND OF THE INVENTION

It is well-known in the art of food preparation that a whisk is a desirable utensil for mixing or emulsifying cooking or baking materials such as oils, eggs, batters, sauces or dressings. Commonly known whisks in the art of culinary cuisine include Balloon Whisks, Ball Whisks, Flat Whisks, and Twirl Whisks. See for e.g. U.S. Pat. Nos. 4,735,510 and 5,788,368, for whisks known in the art.

In culinary cuisine, “whisking” is known as the process of rapidly whipping or lightly beating a food mixture, sauce or emulsion. Whisking requires one hand to hold the bowl or pan containing the mixture, stirring or “whisking” with the other, and adding additional ingredients such as oil, vinegar, eggs, flour or sugar. For example, the creation of a basic vinaigrette dressing requires the use one hand to whisk liquids existing in the bowl, while the second hand dispenses liquids, such as oil into the emulsion.

An emulsion is a mixture of two liquids that normally cannot be combined. Oil and water is the classic example. Emulsifying is done by slowly adding one ingredient to another while simultaneously mixing rapidly. This disperses and suspends tiny droplets of one liquid through another.

The use of the conventional kitchen whisk in the creation of emulsions, batters, sauces, dressings and the like can often be a difficult, messy and cumbersome task. Typically, the culinary chef or cook will use one arm to whisk, while the other arm adds the ingredients. However, this leaves the bowl vulnerable to tipping, and spillage of the ingredients can easily occur. Thus, the chef or cook is often forced into an uncomfortable balancing act of using two arms to carry out three tasks: (1) whisking; (2) adding ingredients; and (3) holding the bowl. When using a conventional whisk, one is typically forced into an uncomfortable position of the arms when trying to balance the bowl, while whisking and dispensing ingredients all at the same time.

Another limitation of using a conventional whisk is the accumulation of too much or too little of the ingredients being added to the mixture which often leads to spilling or inadequate mixing or emulsion of the ingredients in the bowl. Hand-eye coordination and extreme skill are required to avoid spills of non-emulsified sauces, dressings and other preparations caused by use of conventional kitchen whisks.

In order to rectify the problems associated with conventional whisks, those skilled in the art of culinary cuisine frequently have to set the bowl down and suspend the whisking process in order to free up a hand to add the additional ingredients, or ask another person to either hold the bowl or add the ingredients. However, a third helping hand is often not available and suspending the whisking process is both inconvenient and can lead to a non-emulsified mixture.

What is desired therefore is a whisk that allows easy and consistent dispensing of ingredients for the creation of emulsions and mixtures. A whisk that is able to store and dispense ingredients through the whisk itself, would not only eliminate the problem imposed by the “third arm” dilemma but would also lead to better and more uniform tasting sauce, dressing, baked goods or other preparations, as well as to a more consistent mixture or emulsion. In particular, it would be advantageous if a whisk allowed one to easily control the addition of ingredients into a mixture being whisked or emulsified. Accordingly, it is the aim of the present invention to provide an whisk adapted for use in dispensing ingredients. A further aim of the invention is to provide an improved whisk for efficiently creating emulsions, sauces, batters, food mixtures and the like.

### BRIEF DESCRIPTION OF THE DRAWINGS

FIG. 1 is a perspective of a whisk depicting one embodiment of the invention.

FIG. 2 is a perspective of a whisk depicting a second embodiment of the invention.

FIG. 3 is a perspective of a whisk depicting a cross-section of a whisk handle in one embodiment of the invention.

FIG. 4 depicts an embodiment of the invention indicating a preferred location of the control trigger.

FIG. 5 depicts another embodiment of the invention indicating a second preferred location of the control trigger.

### DESCRIPTION OF THE PREFERRED EMBODIMENTS

Various embodiments of the present invention are described hereinafter with reference to the figures. Elements of like structure or functions are represented with like reference to numerals throughout the figures. The figures are only intended to facilitate the description of some of the embodiments of the invention. They are not intended as an exhaustive description of the invention or as a limitation on the scope of the invention. In addition, an aspect described in conjunction with one embodiment of the present invention is not necessarily limited to that embodiment and can be practiced in conjunction with any other embodiments of the invention.

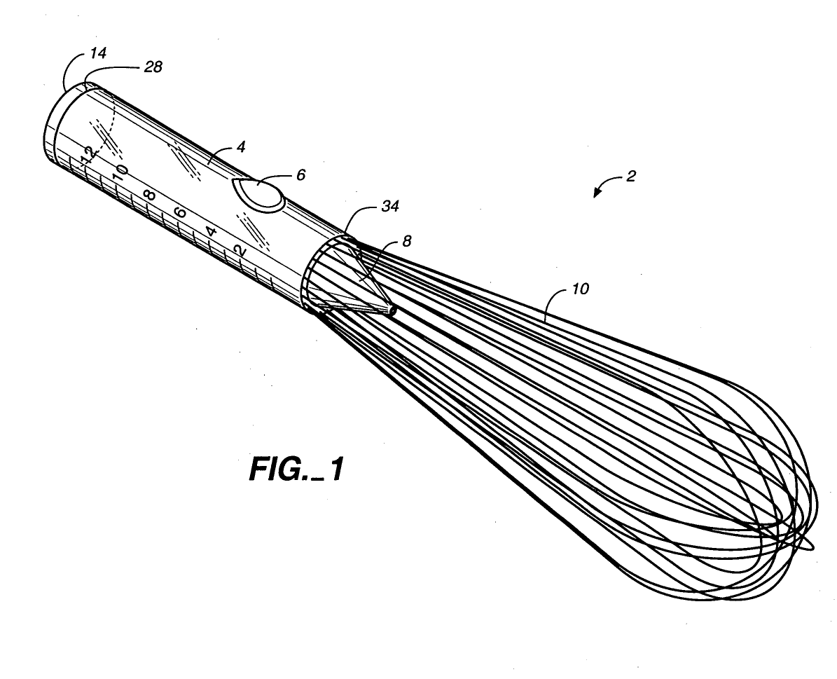

In accordance with one embodiment of the present invention, FIG. 1 depicts generally a single piece whisk apparatus, a whisk 2, with a handle 4, a removable cap 14 at the first end 28 of the handle 4, a control trigger 6 on the outer surface of the handle 4, a dispensing nozzle 8 at the second end 34 of the handle 4, and whisk elements 10. The whisk elements 10 in this particular embodiment are of the balloon type whisk, commonly used in the preparation of sauces, emulsions, batters, and the like. However, the apparatus of the present invention contemplates the use of other types of whisk elements, for example, ball whisks, flat whisks, wire whisks, trimmed whisks and twirl whisks are adaptable in the present invention.

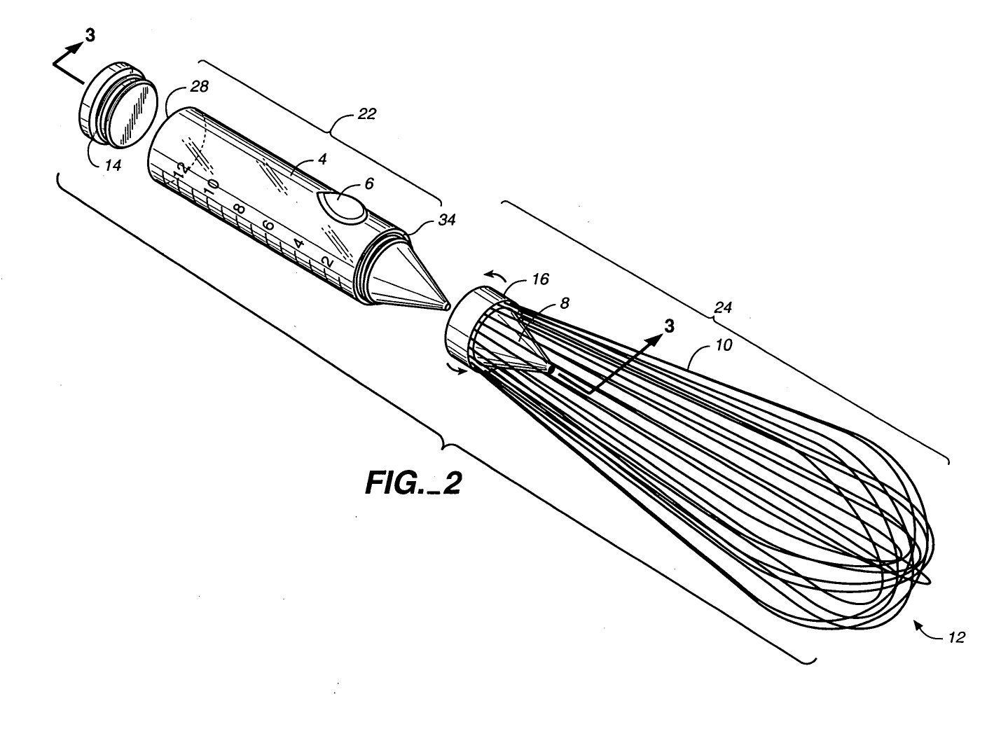

In another embodiment of the invention, FIG. 2 depicts a two piece detachable whisk 12, comprising a first piece 22 and a second piece 24. The first piece 22 includes a handle 4, with a removable cap 14 at first end 28 of the handle 4, and trigger control 6 on the outer surface of the handle 4, and an opening 32 for receiving the second piece 24. In this particular embodiment, second piece 24 comprises a fastening means 16 for connecting the second piece 24 to first piece 22, a nozzle 8 and whisk elements 10. It should be noted that fastening means 16 can utilize any conventional method of fastening, including but not limited to a screw mechanism, male part and female part secure fit mechanism, lock and clasp mechanism, and any other suitable means for securely attaching first piece 22 to second piece 24 such that ingredients resident within the inner chamber of handle 4 will not leak out at the site of connection and will flow seamlessly through first piece 22 into second piece 24 through the nozzle 8 for dispersing the ingredients into the bowl or container.

One advantage of the two piece embodiment is that several types of whisking elements, such as flat whisks, balloon whisks, ball whisks, rotary whisks, etc. can be used with a second piece 24. Thus, the first piece 22 of the whisk 12, which includes the means for dispensing ingredients from the handle 4 can be utilized with several different types of second piece attachments. Another advantage of the two piece embodiment is that it allows for easy cleaning by exposing the hard to reach places inside the whisk handle 4 where ingredients are housed and the nozzle 8 from which the ingredients are released.

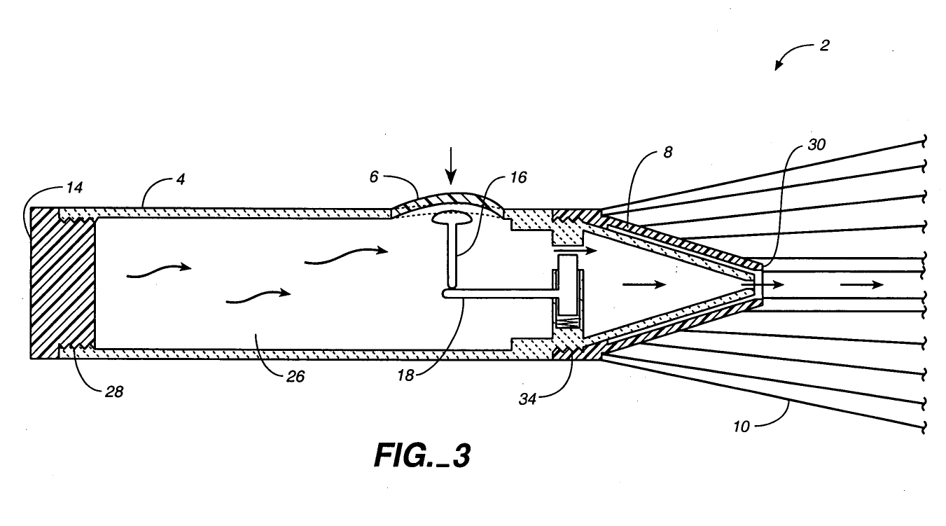

FIG. 3. shows a cross-sectional view of the handle 4 which contains the inner refillable chamber 26 for housing ingredients via the removable cap 14. The removable cap 14 provides a point of access for pouring ingredients into the inner refillable chamber 26 and can be made of plastic, stainless steel, or any other suitable material. The removable cap 14 covers the opening at the first end 28 of the handle 4. The removable cap 14 may take the form of any conventional type of cap such as screw cap, pin cap, hinge cap, or insert which can sit securely at the first end 28 and provide a air-tight moisture free seal to prevent liquids and other ingredients from leaking out of the first end 28 of the handle 4. The purpose of the inner refillable chamber 26 is to store ingredients such as oil. The volume of the inner refillable chamber 26 may vary depending on the diameter of the handle chosen. The present invention contemplates utilizing handle diameters of various length to accommodate different volumes of ingredients.

FIG. 3 also depicts a trigger control 6 which can activate the dispensing mechanism for releasing ingredients from the inner refillable chamber 26. Particularly, in this embodiment, the dispensing mechanism includes a trigger control 6 which is resident on the outer surface of the handle 4, coupled to a valve 18 via a trigger pin 16. Upon activation of the trigger control 6 by a user (e.g. by tactile pressure), the trigger pin 16 forces the valve 18 open, thereby allowing ingredients stored in the inner refillable chamber 26 to flow freely through the nozzle 8, out through opening 30, and into the mixing apparatus or container. In this embodiment, the nozzle 8 is positioned along the center axis of the handle 4 at second end 34, surrounded by whisking elements 10 which form a symmetrical cage around the nozzle 8. The position of the nozzle 8 relative to the handle and whisking elements may vary depending on the type of whisking element and diameter of handle utilized.

With reference to FIG. 3, that the dispensing means depicted, i.e. trigger control 6, trigger pin 16 and valve 18, coupled to a nozzle 8 are component parts of a preferred embodiment, and that other embodiments of the invention may utilize other types of components to affect the release of ingredients from the inner refillable chamber 26. For example, in another embodiment of the invention, the trigger control 6 may be coupled directly to the valve 18, which upon being depressed can cause the valve 18 to open and allow ingredients to flow from the inner refillable chamber 26 through opening 30. Also, the invention is not limited to the use of a nozzle 8 to dispense ingredients from the inner refillable chamber 26. In other embodiments of the invention, the second end of the handle may be defined by a hole or opening which is coupled to a valve, such that when the trigger control opens the valve, the ingredients from the inner chamber flow out through the hole or opening into the bowl or container.

In a preferred embodiment depicted in FIG. 1 the nozzle 8 is simply a narrow extension of handle 4 which tapers into a conical shape and opening 30, an opening that may vary in diameter, but which is smaller in diameter than the opening at first end 28. In FIG. 2, the nozzle 8 depicted is a component of the second piece 24 and not an extension of handle 4.

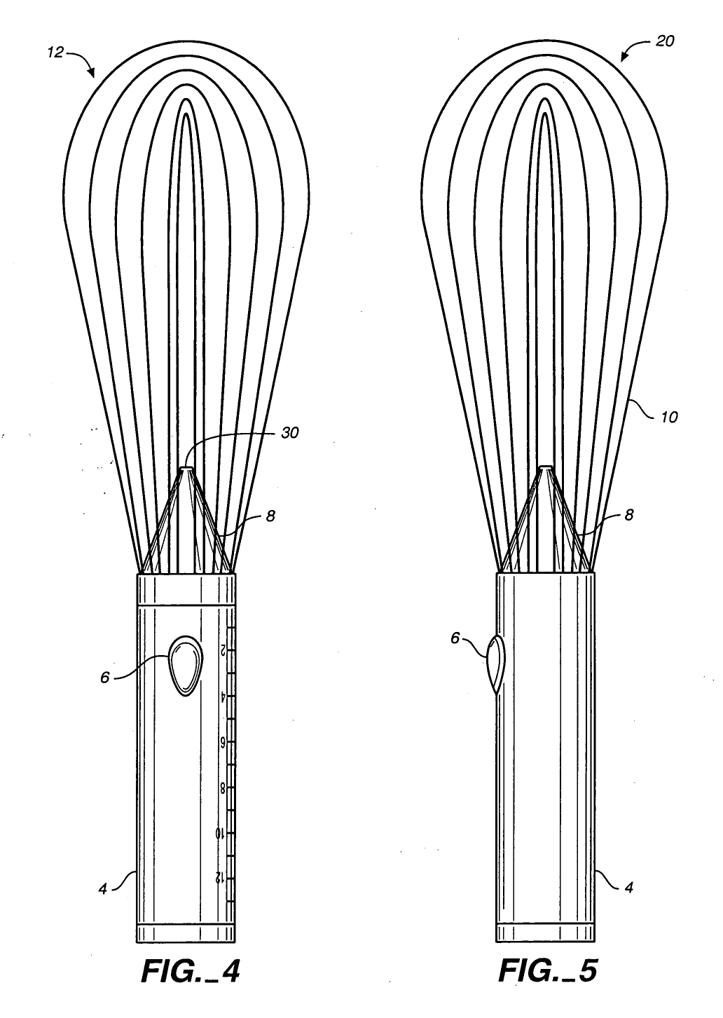

FIG. 4 depicts an alternative embodiment where the control trigger 6 is positioned on the ventral planar surface of the handle 4 with respect to the whisking elements 10, such as would be convenient for use with the forefinger of the user.

FIG. 5 depicts a whisk 20 in accordance with another embodiment of the present invention where the control trigger 6 is positioned at a right angle to the ventral planar surface of the whisking elements 10, on the left side of the handle 4, such as would be suitable for use with the thumb of a right-handed user. It should be appreciated that the position of the trigger control in other embodiments of the invention may be situated in a position which is convenient for use by a left-handed person.

In yet another embodiment of the invention the nozzle 8 depicted in the various figures may consist of any type of conventional nozzle suitable for releasing liquids at a controlled flow rate. The nozzle may reside at the second end 34 of handle 4 as depicted in FIG. 1, or may form a component of the second piece in the detachable whisk embodiment shown in FIG. 2. The nozzle serves generally as a conduit for moving ingredients from the inner refillable chamber 26 into the bowl or mixing apparatus at a controlled rate. The passage of ingredients into the bowl through a nozzle can by driven by gravity and or the centripetal force caused by the circular whisking motion. Moreover, the amount of ingredients to be released through a nozzle can be controlled by the trigger control which controls the opening of the valve and determines how much liquid leaves the nozzle.

In other embodiments of the invention, the means for dispensing ingredients from the handle is actuated by a pump, syringe or other suitable mechanical means for directing liquid from a container and through an opening.

Still in another embodiment of the invention, the whisk handle may include indicia or means for measuring the volume of ingredients stored within the inner refillable chamber. The measuring indicia may utilize any conventional volume measuring system such as in metrics (for e.g. milliliters) or in the U.S. system (e.g. cups and ounces). Such a handle may be transparent to the user, to allow the user to view and measure the ingredients directly, or in the alternative utilize any other conventional measuring method or system.

Although the invention has been described with reference to a particular arrangement of parts, features and the like, these are not intended to exhaust all possible arrangements or features, and indeed many other modifications and variations will be ascertainable to those skilled in the art. The claims, and only the claims, limit the scope of the claimed invention.

What is claimed is:

1. A special purpose whisk adapted to dispense ingredients, comprising:
a handle with a first opening at first end for receiving ingredients and a second opening at a second end for dispensing ingredients;
said handle having an outer surface and inner refillable chamber;
a control trigger on said outer surface of said handle;
a valve in said inner refillable chamber coupled to said control trigger for releasing ingredients from said opening at the second end; and
a plurality of whisking elements attached to said handle.

2. A whisk of claim 1 further comprising a removable cap for closing said opening at first end.

3. A whisk of claim 1 further comprising measuring means for measuring the volume of ingredients within the inner refillable chamber.

4. A special purpose whisk adapted to dispense ingredients, comprising a first and second piece:
said first piece comprising a handle with opening at first end for receiving ingredients and a second end defined by an opening for receiving a second piece;
said handle comprising an outer surface and inner refillable chamber;
a control trigger on the outer surface of said handle;
a valve in said inner refillable chamber coupled to said control trigger;
said second piece comprising: fastening means for connecting said second piece to said first piece; a nozzle positioned such that when said second piece is connected to said first piece, said nozzle is coupled to said valve for receiving ingredients from said inner refillable chamber for release from said nozzle; and
a plurality of whisking elements attached to said second piece.

5. A whisk of claim 4 further comprising a removable cap for closing said opening at said first end.

6. A whisk of claim 4 further comprising measuring means for measuring the volume of ingredients within the inner refillable chamber.

7. A special purpose whisk adapted to dispense ingredients, comprising:
a handle with opening at first end for receiving ingredients and an opening at second end for dispensing ingredients;
said handle comprising an outer surface and inner refillable chamber;
means for dispensing ingredients from said handle at a second end of said handle; and
a plurality whisking elements attached to said handle.

8. The whisk of claim 7 further comprising a removable cap for closing said opening at first end.

9. A whisk of claim 7 further comprising measuring means for measuring the volume of ingredients within the inner refillable chamber.
